(19) United States
(12) Patent Application Publication
(10) Pub. No.: US 2014/0348013 A1
(43) Pub. Date: Nov. 27, 2014

(54) DEVICE AND METHOD FOR COLLECTING INFORMATION RELATING TO ACCESS POINTS

(71) Applicants: Stéphane Terrenoir, Toulouse (FR); Baptiste Godefroy, Saint Sulpice Sur Leze (FR); Jaouad Chouki, Toulouse (FR); Yan Bertrand, Toulouse (FR)

(72) Inventors: Stéphane Terrenoir, Toulouse (FR); Baptiste Godefroy, Saint Sulpice Sur Leze (FR); Jaouad Chouki, Toulouse (FR); Yan Bertrand, Toulouse (FR)

(73) Assignee: POLE STAR, Toulouse (FR)

(21) Appl. No.: 14/344,888

(22) PCT Filed: Sep. 14, 2012
(86) PCT No.: PCT/EP2012/068052

§ 371 Date: Mar. 13, 2014

(30) Foreign Application Priority Data
Sep. 15, 2011 (FR) 1158208

(51) Int. Cl. H04W 48/16; H04W 4/02

(52) U.S. Cl. CPC H04W 48/16; H04W 4/02
USPC 370/252

(57) ABSTRACT

A device and a method of collecting information about access points in a wireless telecommunication system, for example RSS fingerprints in a Wi-Fi network, are disclosed. Information can be collected automatically along a user's path, using a mobile terminal. The mobile terminal is provided with display means for displaying the zone in which the mobile terminal moves around. The mobile terminal also includes pointing means to point at a location on a map. When the user is positioned at the location pointed at by the pointing means, the user can validates the user's position using validation means. Information collected along the path and coordinates of each validated position are time-stamped using a clock in the mobile terminal.

### TECHNICAL DOMAIN

This invention relates to the domain of collecting information about access points in a wireless telecommunication network. Its applications are particularly positioning of a mobile terminal using RSS fingerprints in an indoor type environment.

### STATE OF PRIOR ART

Satellite positioning systems are well known in the state of the art. The latest generation mobile telephones called smartphones usually comprise GPS receivers capable of positioning the user. However, this positioning system is not operational when the user is inside a building and in general in an indoor type environment. It is known that positioning can then be achieved by means of one or even several wireless telecommunication networks deployed in said environment, for example a third generation mobile telephony network or a Wi-Fi network.

We will use the generic term “access point” in the following description to refer to a transmitter/receiver capable of providing access to a wireless telecommunication network. Thus, an access point corresponds to a base station (BTS) in a GSM or UMTS type cellular telecommunication network, or even a WiMAX type wireless network, and an access terminal in a Wi-Fi network.

Several positioning methods using access points are known in the state of the art.

A first method consists of determining the user's position from the transmission powers of different access points, their corresponding positions, and the Received Signal Strength (RSS) of these access points at the mobile terminal. However, this method is sensitive to multi-paths and in practice requires relatively complex calculations making use of a propagation model in the terminal environment. Satisfactory results cannot be obtained unless the environment in question is modelled in detail and consequently requires high development costs.

A second method consists of collecting prior measurements of signal strengths received from different access points, in advance in the field. This collection may be made systematically or in cooperation, but it always requires acquisition of a large number of measurements that are then stored in a database. In general, identifiers of access points and received signal strengths (RSS) are stored for each measurement location, at each of these points. The set of identifiers related to measured powers is a characteristic of the measurement location, also called the RSS fingerprint of the location in question.

When a user would like to determine his position using his mobile terminal, the terminal measures the powers received from the surrounding access points (APs). The list of access points with their corresponding strength levels, in other words the RSS signature obtained by the terminal, is then compared with the RSS signatures present in the database. The position of the terminal is then determined from the locations for which the RSS signature is closest to the signature obtained by the terminal.

Prior acquisition of radio signatures is a tedious and expensive operation. Furthermore, the database that contains them must be regularly updated to take account of possible changes in the environment.

A software tool called the <<Place Lab Spotter>> has been developed so that a mobile terminal can scan its environment in real time (strengths received from Wi-Fi access points, GSM, etc., depending on the envisaged platform) and the GPS position of the terminal can be associated with each measurement. However, this tool only works correctly in zones where GPS positioning is available; therefore, it is not suitable for positioning in an indoor type environment. For example, a description of the software tool mentioned above is given in the article by T. Sohn et al. entitled <<Experiences with Place Lab: an open source toolkit for location aware computing>>, published in Proc. of the 28th International Conference on Software Engineering (ICSE 2006).

Furthermore, at the present time, there is no mobile terminal with a friendly interface enabling real time acquisition and fast collection of RSS signatures in a given environment.

One purpose of this invention is to disclose a method and a device for collecting information about access points in at least one wireless telecommunication network, and especially RSS signatures, that is particularly easy and fast to use.

### PRESENTATION OF THE INVENTION

This invention is defined as a mobile terminal designed to collect information about access points in at least one wireless telecommunication network, comprising:

means of displaying a map of a zone of interest;

means of pointing at a location on this map;

validation means to validate that the position of the terminal user is the position of the location pointed at by pointing means on said map;

software means to:
trigger acquisition of information about access points in the wireless telecommunication network at successive times, said information being time-stamped using a clock in the mobile terminal;
record the coordinates of the location pointed at by said pointing means, each time that the user's position is validated by said validation means, the coordinates also being time-stamped by said clock.

In particular, information about access points may include strength levels of the signals received by said terminal from these access points.

Alternately, information about access points may include a detection/non-detection indication of at least one of said access points.

Furthermore, information about access points may include an identifier of each access point.

Finally, information about access points may include a round trip propagation time between the mobile terminal and each access point.

According to one embodiment, the mobile terminal comprises a GPS receiver and software means trigger the acquisition of visibility information for the various satellites at said successive times, said information being time-stamped using said clock.

Furthermore, the terminal may generally comprise at least one sensor of a physical quantity, the software means triggering physical measurement acquisitions using said sensor at said successive times, said measurements being time-stamped by said clock. Said sensor belongs to a set composed of an accelerator, a velocitymeter, a magnetometer (such as an electronic compass) and a barometer.

The display means may include a touch screen and the pointing means include a pointing pattern displayed on said screen.

The pointing pattern may be fixed relative to the touch screen.

The map may be displaced as a function of the attitude of the terminal.

Alternately, the map may be displaced as a function of the user's speed and movement direction.

The validation means may automatically validate the user's position when a change of movement direction is detected.

The invention is also defined as a method of collecting information about access points in at least one wireless telecommunication network in a zone of interest, using the mobile terminal presented above, according to which the user's position is determined for each acquisition of said information at the time of said acquisition by making an interpolation between:
a first user position validated by validation means at a first validation time before said acquisition time;
a second position of the user validated by validation means at a second validation time after said acquisition time.

The user's position thus determined by interpolation is associated with information about access points in the wireless telecommunication network obtained by the mobile terminal at the time of said acquisition.

The user's position and said information about access points are advantageously sent to a remote server and are stored in a database.

The server can determine a coverage indicator in the zone of interest and send it to the mobile terminal to display it on the screen of this mobile terminal, superposed on the map of said zone.

The server may also determine a positioning quality indicator in the zone of interest and send it to the mobile terminal to display it on the screen of this mobile terminal superposed on the map of said zone.

Finally, the user may be provided with at least one other terminal. In this case, this other user's terminal may be adapted to synchronise its clock with the clock of the mobile terminal and to share the user's position obtained at each validation with it, said other terminal also starting acquisition of second information about access points in the wireless telecommunication network at successive times, said second information being time-stamped using the clock thus synchronised.

The wireless telecommunication network is typically a Wi-Fi network.

### BRIEF DESCRIPTION OF THE DRAWINGS

Other characteristics and advantages of the invention will become clear after reading a preferred embodiment of the invention with reference to the appended figures among which:

FIG. 1 diagrammatically shows a mobile terminal that will collect information about access points in a wireless telecommunication network, according to one embodiment of the invention;

FIG. 2 diagrammatically shows collection of information about access points along the path of a user holding the mobile terminal shown in FIG. 1.

### DETAILED DESCRIPTION OF PARTICULAR EMBODIMENTS

In the following, we will consider a mobile terminal moving around in an environment in which at least one wireless telecommunication network is deployed, for example a GSM, UMTS, Wi-Fi, WiMAX, or Bluetooth type network. This network comprises a plurality of access points in the meaning defined above. The environment is not necessarily of the indoor type, but the invention is advantageously applied to this type of environment for which GPS positioning is not available.

The mobile terminal can collect information about access points in the wireless telecommunication network, this collection being made along a path or an itinerary of the user in said environment. Information about access points in the different networks can be collected in parallel if several networks are present in the user's environment. Information about network access points refers to access point parameters as measured, detected or estimated by the mobile terminal at a given location. Typically, the parameter of an access point could be the received strength signal (RSS) of the access point in question or detection/non-detection of this access point by the mobile terminal (for example received strength greater than a certain threshold). According to one variant, the parameter of an access point could be the Round Trip Delay (RTD) between the transmission time of a request to the access point sent by the mobile terminal, and the reception time by this terminal of the acknowledgment of reception from the access point. Other types of parameters could be envisaged by those skilled in the art without going outside the scope of this invention.

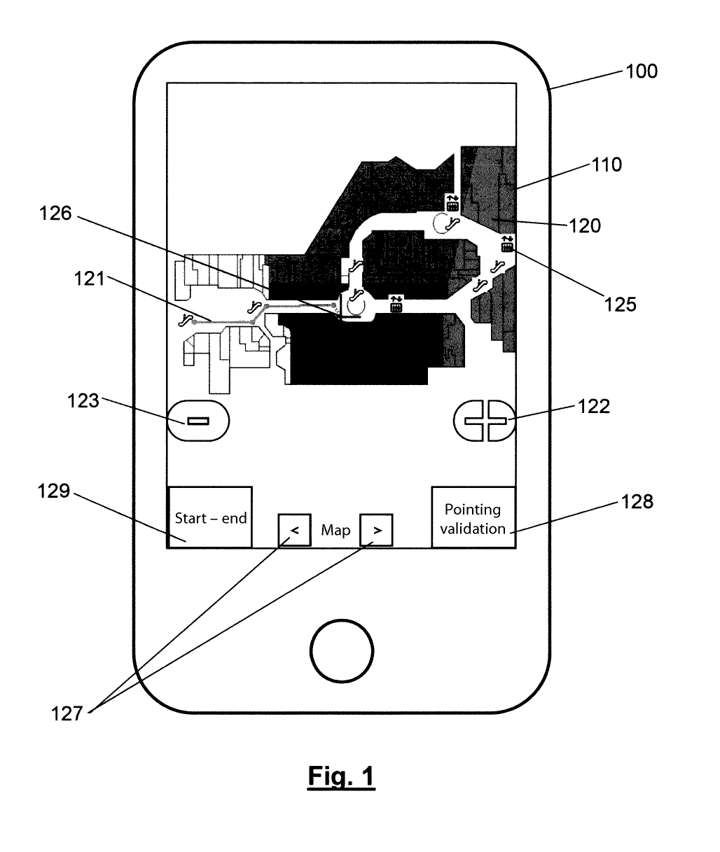

FIG. 1 diagrammatically shows a mobile terminal according to one embodiment of the invention. This mobile terminal 100 is designed to collect information about access points in a wireless telecommunication network.

The terminal 100 comprises display means 110 such as a graphic interface, typically a touch screen.

The display means are capable of displaying an environment map 120 in which the user of the mobile terminal is moving. This map may be a geographic map (outdoor use) or a map of the premises (indoor use) that may be enriched by bench marks and/or Points Of Interest (POI) 125, facilitating positioning of the user. In special cases, the environment map may be a 3D map.

Advantageously, the environment map includes a graphic representation 121 of the path already followed by the user.

The user can zoom the environment map by using the zoom in (+) button 122 and the zoom out (−) button 123 in a manner known in itself. These buttons may be materialised by symbols on the touch screen or they may be distinct physical keys separate from the screen. The zoom in or zoom out may also be made by moving the fingers further apart or closer together (zoom<<pinch>>) on the touch screen, in a manner known in itself.

In all cases, pointing means 126, for example a pointing pattern, are used to select any point on the map 120 with good precision. In other words, the pointing means enable the user to point at any location on this map.

According to one variant embodiment, the pointing means are composed of a fixed pointing pattern relative to the touch screen. For example, it may be located in the middle of this screen. In this variant, optional displacement buttons may be provided for moving around on the map 127 so that the user can move the map relative to the pointing pattern. Alternately, the user can simply move the map by sliding it with his finger or a stylus.

According to another variant embodiment, the pointing means consist of a mobile pointing pattern free to move relative to the touch screen. It may be moved as above using displacement buttons to select a point on the map. If applicable, it will also be possible to slide the map using a finger or a stylus to enable more flexible use.

According to yet another variant embodiment, if the terminal is equipped with a gyroscope, particularly a MEMS gyroscope, the map may be displaced by varying the attitude of the sensor. Thus, tilting the terminal forwards can move the map forwards, etc.

According to another variant, the map may be displaced automatically as the user moves. However, this variant assumes that the user's position can be estimated as he moves around.

The terminal also comprises validation means, for example a validation button 128. This validation button may be materialised by an icon on the touch screen or it may be a distinct physical key separate from the screen, that may or may not be dedicated. The validation means enable the user to validate that the user's position is the position pointed at by the pointing means, as explained below.

Alternately, validation means do not necessarily require manual action by the user. For example, the validation means can detect a change in the user's direction of movement between two straight segments of the path. The change in direction is then interpreted as validation of the location pointed at by the pointing means. However, this variant assumes that the path is polygonal and that the vertices of the polygon are pointed at in sequence.

Map or pattern displacement, pointing and validation commands may be controlled by voice. For example, in the case of a polygonal path, the user can give a voice command to signal his intention to go to the next vertex. He will be able to validate his position by a voice command when he reaches this vertex. This voice command may also automatically start pointing onto the next vertex.

An optional on/off button 129 can start/stop execution of an application for the collection of information about access points in the network(s). Alternately, this application can be run permanently as a background task or as soon as a network is detected.

This application comprises software means to:
trigger acquisition of information about access points in the wireless telecommunication network at successive times, said information being time-stamped by means of a clock in the mobile terminal;
record coordinates of the location pointed at by said pointing means, at each validation of the user's position by said validation means, the coordinates being also time-stamped by said clock.

The mobile terminal clock may or may not be synchronised with a reference clock, for example a server clock, using the NTP (Network Time Protocol) protocol.

When the collection application has been started, the mobile terminal acquires said information at successive times. The terminal collects the following data at each acquisition time:
a) information about the different access points, each information being associated with the identifier of an access point to the wireless telecommunication network;
b) the time at which said information was acquired.

Note that acquisition may be made in synchronous mode at regular intervals, or in asynchronous mode. Depending on the type of operating system of the terminal, the application may or may not control the acquisition time directly. Thus in some cases, the application can simply request acquisition by the terminal and receive an acknowledgement when the acquisition has been done. Regardless of the mode used, the information acquired is time-stamped by the collection application.

At the time of each acquisition, time (b) is used to time-stamp the information (a). This time-stamping is advantageously done using the system clock of the mobile terminal or any other available clock, that may or may not be synchronised with an external reference clock, for example a server clock as explained above.

Information about an access point may for example be the received signal strength (RSS) from this point or it may be Boolean information about detection/non-detection of this point by the mobile terminal. Obviously, this information depends on the location of the user at the time of the acquisition. Alternately, information about the access point may be the time t_{RTD} between the transmission time (by the mobile terminal) of a query to the access point and the reception time (by this terminal) of the response (acknowledgement of reception) sent by the access point. According to this variant, the mobile terminal can advantageously deduce the processing time τ_{AP} specific to the access time from the time t_{RTD} in order to obtain the round trip delay, in other words the sum of the query propagation time and the response propagation time. The processing time τ_{AP} may be determined by the mobile terminal in different ways, for example using a table containing times τ_{AP} of the different types of access points, stored in a mobile terminal, and the response of the access point specifying the type to which it belongs. The processing time may also be obtained by means of a calibration phase or by means of statistics once the mobile terminal has been located. More precisely, once the mobile terminal has been positioned, and knowing the position of an access point AP, τ_{AP} can be estimated by taking the difference between the time t_{RTD} and the round trip delay t_{RTD}⁰, either in a direct line of sight or using a particular propagation model (NLOS).

When several wireless telecommunication networks are present in the zone in which the user is located, information (a) may relate to access points in the different networks.

Other information, for example physical measurements, may be collected in parallel.

For example, if the mobile terminal is equipped with a GPS receiver, it may collect visibility data from the different satellites at each acquisition time. These data indicate which satellites are visible from the mobile terminal at the time in question, in other words the satellites from which it actually detects the positioning signal.

Similarly, if the mobile terminal is equipped with one or several sensors such as a magnetometer, accelerometer, velocity sensor, barometer, etc., it may also collect physical measurements (magnetic field intensity and/or direction, acceleration, velocity, pressure, etc.) at each acquisition time. Therefore, these measurements will be time-stamped in the same way as information about access points.

The data thus collected and time-stamped may be stored in the memory of the mobile terminal for subsequent processing or may be sent to a server after a predetermined number of acquisitions or even at each acquisition.

In any case, when the user would like to show that he is located at a given position, he points using pointing means at the point on the map representing this location and validates his position using the validation means. For example, the user points at the location with the pointing pattern and validates his position by pressing on the validation button. Advantageously, for reasons of efficiency, the user may firstly position the pointing pattern on the point on the map representing the location to which he would like to move and validate his position when he reaches this position.

According to one variant embodiment, the user has several terminals capable of communicating with each other (for example using Bluetooth connections). The user may then simply point at and validate only one of them, the validated position then being shared between the different terminals. Furthermore, the clocks of the different terminals may be synchronised with each other. This variant can considerably increase the quantity of information calculated as a user passes. It can also improve the reliability of measurements by taking averages on several collocated terminals.

The software means record the following data every time that a position is validated:
a′) coordinates of the location on the map by the pointing pattern at the time of the validation;
b′) time at which the position was validated.

Time (b′) is used to time-date the passage of the mobile terminal at the location indicated by (a′). Time-dating is done with the same clock as that used to time-date information about access points (a).

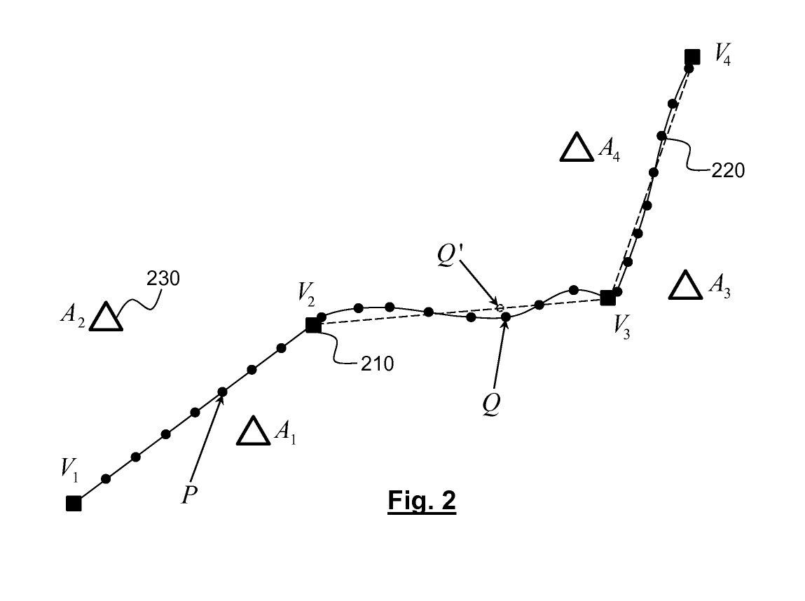

FIG. 2 diagrammatically shows an example of collection of information about access points when a user equipped with the mobile terminal described above moves along a path 200.

The locations at which the user validated his position are shown by the symbol 210 and are denoted V₁ to V₄ and the locations at which the terminal made an acquisition of information about access points are shown by the symbol 220. Access points in the wireless telecommunication network (for example a Wifi network) are shown by the symbol 230 and are denoted A₁ to A₄.

The user's path is ideally linear between two validation times and the displacement speed is preferably constant.

It is assumed in the figure that these conditions were satisfied between points V₁ and V₂. Acquisition points 220 are then distributed along the segment V₁V₂.

The coordinates (for example latitude, longitude, altitude) of points V₁ and V₂ are known from their corresponding positions on the map, recorded at the time of the validation.

The coordinates of any acquisition point P located between V₁ and V₂ can then be obtained by simple interpolation from the coordinates of points V₁ and V₂.

Therefore, the coordinates thus calculated and the information about access points in the network can thus be associated with each acquisition point P (also optionally additional physical measurements as mentioned above). In the case shown, the mobile terminal will only detect access points A₁ and A₂ at point P. The information acquired at P will for example be (Id(A₁), RSS₁) and (Id(A₂), RSS₂) in which Id(A₁), Id(A₂) are identifiers of access points A₁ and A₂, and RSS₁ and RSS₂ are the signal strength levels received from access points A₁ and A₂ at point P. For example, if the wireless telecommunication network is a Wi-Fi network, identifiers may be the BSSID (Basic Service Set IDentifier) numbers of the access terminals.

In practice, as shown on the portion of the path between points V₂ and V₃, straight line displacement and constant speed conditions are not perfectly satisfied. Therefore the real path (in a continuous line) is different from the ideal path (in dashed lines), and the point Q′ that would be obtained by interpolation of the coordinates of V₂ and V₃ is different from the real acquisition point, Q. Nevertheless, the difference is often acceptable considering the degree of precision of the required positioning.

According to one variant, the mobile terminal may be equipped with an inertial navigation system, for example using a MEMS accelerometer so as to measure the user's displacement speed at each acquisition point. The user's movement direction may also be obtained using a magnetometer (electronic compass). It is then possible to estimate the positions of the real acquisition points Q. The coordinates of the real point Q may be calculated in step by step using the coordinates of the validation point (V₂ or V₃) located immediately before or after on the path. It will be assumed for this purpose that the displacement speed and the user's movement direction are constant between two successive acquisition points.

Alternately, if all that is available is the user's movement direction at each acquisition point (for example provided by an electronic compass), the coordinates of the real points between two validation points can be obtained by minimising a cost function. This can be done by assuming that the displacement speed (its norm) is approximately constant between two validation points. The cost function may in particular be based on a difference from the coordinates of the next validation point (or the previous validation point if the time axis is reversed).

In any case, the coordinates thus calculated and information about the access points can be associated with any real acquisition point Q, as explained above.

It will thus be understood that a database of RSS signatures (and/or visibility data) can quickly be created with good precision on the position of the acquisition points. The user's collection tasks is very much facilitated by the automatic acquisition of these signatures. However, the precision of these measurements is not sacrificed due to position validation operations carried out from time to time by the user along his itinerary.

If required, the collected information already present in the database can be used to more or less approximately estimate the terminal position, the positioning precision improving as the collection progresses.

Previously stored information may be combined with information currently being collected to estimate the user's position. Thus, the user can observe the improvement in positioning precision in real time. The server helps to achieve this by estimating the user's position using the most recent information sent by the terminal and the information already stored in the base (map of RSS and other measurements). The position is estimated with a degree of precision that will result in an uncertainty disk. The user can verify if his real position is within the uncertainty disk, and notify the server (error message) if there is an inconsistency.

In cooperative mode, several users each equipped with a terminal like that disclosed above will move about within the same geographic zone of interest. Data acquired by a terminal and stored in the base may then be used by another terminal for its own positioning.

Each user can have an itinerary to follow in the zone of interest or he may choose between several itineraries. He may also freely choose his itinerary depending on previously followed itineraries. Itineraries may be saved centrally by the server and be displayed on the map of each terminal.

Advantageously, in cooperative mode or not in cooperative mode, the server updates a map of the coverage of the zone of interest (density of acquisition points, previously followed trajectories). This coverage information (or coverage indicator) may be sent by the server to the terminal to be displayed on the terminal screen, superposed on the map of said zone. The user can then determine his itinerary by giving priority to the least densely covered parts.

Alternately or additionally, and also possibly but not necessarily in cooperative mode, the server can keep an up—to-date map of the positioning quality obtained using information about access points previously stored in the database. The positioning quality may be shown by an indicator taking account of the density of acquisition points, the number of access points seen at each acquisition point (for example size of the RSSI measurement vector), etc. The quality indicator may be displayed on the touch screen using a colour code (heatmap).

Finally, the user is guided in his movement by the display of the map on the terminal screen. As mentioned above, the map may be moved using a manual or voice command. The map may alternately be moved in automatic mode (it being understood that manual mode may replace automatic mode at any time). In automatic mode, the map is displaced as a function of the user's velocity and movement direction. The user's speed may for example be obtained using MEMS sensors fitted on the terminal or by calculating the average speed between two validated positions. The movement direction may be supplied either by a magnetometer (electronic compass) or by the vector joining the last validation point and the current position of the pattern (in this case it is assumed that the user has moved the pattern after the last validation to indicate the direction that he is following). Based on the speed and the movement direction estimated in this way, the map can be automatically displaced on the screen (depending on the scale).

If the zone of interest comprises several levels (for example different floors in a building), a map will be associated with each level. As soon as a level change is detected (vertical speed component, detection of an identifier of an access point on a floor, selection or increment/decrement of a floor by the user using an action button on the touch screen), the map of this floor may be automatically loaded, keeping the centring on the horizontal coordinates of the previous map, to achieve continuity of guidance.

1. A mobile terminal designed to collect information about access points in at least one wireless telecommunication network, comprising:
means of displaying a map of a zone of interest;
means of pointing at a location on the map;
validation means to validate that a position of a terminal user is the position of the location pointed at by pointing means on the map;
software means to:
trigger acquisition of information about access points in the wireless telecommunication network at successive times, the information being time-stamped using a clock in the mobile terminal;
record the coordinates of the location pointed at by the pointing means, each time that the user's position is validated by the validation means, the coordinates also being time-stamped by the clock.

2. The mobile terminal according to claim 1, wherein the information about access points comprises strength levels of the signals received by the terminal from these access points.

3. The mobile terminal according to claim 1, wherein the information about access points comprises a detection/non-detection indication of at least one of the access points.

4. The mobile terminal according to claim 2, wherein the information about access points also comprises an identifier of each access point.

5. The mobile terminal according to claim 1, wherein the information about access points comprises a round trip propagation time between the mobile terminal.

6. The mobile terminal according to claim 1, comprising a GPS receiver and wherein the software means trigger the acquisition of visibility information for various satellites at the successive times, the information being time-stamped using the clock.

7. The mobile terminal according to claim 1, comprising at least one physical magnitude sensor and wherein the software means start physical measurement acquisitions using the sensor at the successive times, the measurements being time-stamped by the clock.

8. The mobile terminal according to claim 7, wherein the sensor is selected from the following: an accelerator, a velocity meter, a magnetometer and a barometer.

9. The mobile terminal according to claim 1, wherein the display means comprises a touch screen and the pointing means comprises a pointing pattern displayed on the screen.

10. The mobile terminal according to claim 9, wherein the pointing pattern is fixed relative to the touch screen.

11. The mobile terminal according to claim 9, wherein the map is displaced as a function of the attitude of the terminal.

12. The mobile terminal according to claim 9, wherein the map is displaced as a function of the user's velocity and movement direction.

13. The mobile terminal according claim 1, wherein the validation means validate the user's position when a change of movement direction is detected.

14. A method of collecting information about access points in at least one wireless telecommunication network in a zone of interest, using the mobile terminal according to claim 1, wherein the user's position is determined for each acquisition of the information at a time of the acquisition by making an interpolation between:
a first user position validated by validation means at a first validation time before the acquisition time; and
a second position of the user validated by validation means at a second validation time after the acquisition time.

15. The method according to claim 14, wherein the user's position at the time of the acquisition thus determined by interpolation is associated with information about access points in the wireless telecommunication network obtained by the mobile terminal at the time of the acquisition.

16. The method according to claim 14, wherein the user's position and the information about access points are sent to a remote server and are stored in a database.

17. The method according to claim 16, wherein the server determines a coverage indicator in the zone of interest and sends it to the mobile terminal to display the coverage indicator on the screen of the mobile terminal, superposed on the map of the zone.

18. The method according to claim 16, wherein the server determines a positioning quality indicator in the zone of interest and sends the positioning quality indicator to the mobile terminal to display the positioning quality indicator on the screen of the mobile terminal superposed on the map of the zone.

19. The method according to claim 14, wherein another user's terminal is adapted to synchronise its clock with the clock of the mobile terminal and to share the user's position obtained at each validation with the other user's terminal, the other user's terminal also starting acquisition of second information about access points in the wireless telecommunication network at successive times, the second information being time-stamped using the clock thus synchronised.

20. The method according to claim 14, wherein the wireless telecommunication network is a Wi-Fi network.
